(19) United States
(12) Patent Application Publication
(10) Pub. No.: US 2018/0224078 A1
(43) Pub. Date: Aug. 9, 2018

(54) METHODS AND APPARATUS FOR A MULTI-FUNCTIONAL HIGH EFFICIENCY LED AREA LIGHT

(71) Applicant: Aixia Bian, Shanghai (CN)

(72) Inventor: Aixia Bian, Shanghai (CN)

(21) Appl. No.: 15/581,848

(22) Filed: Apr. 28, 2017

Related U.S. Application Data
(60) Provisional application No. 62/456,898, filed on Feb. 9, 2017.

(51) Int. Cl. F21L 4/08; F21V 23/04; F21V 21/14; F21K 9/64; F21V 31/00; F21V 21/40; F21V 29/77; F21V 29/89

(52) U.S. Cl. CPC F21L 4/08; F21V 23/0414; F21V 21/145; F21K 9/64; F21Y 2115/10; F21V 21/406; F21V 29/773; F21V 29/89; F21V 31/00

(57) ABSTRACT

This invention provides a portable light which comprises a housing with a front portion, a back portion, and a handle; the front portion including a cross shaped support portion and a finned portion; a lighting element is centrally positioned in the front portion; a rotatable stand is connected to the housing at each side; a battery system is coupled to an inside of the housing and operably connected to and enabling the lighting element to emit light with a switch as part of a control panel built into the rear portion of the housing.

### REFERENCE TO RELATED APPLICATION

The present application claims priority to U.S. Application No. 62/456,898, entitled “Methods and Apparatus for a Multi-Functional High Efficiency LED Area Light” and filed on Feb. 9, 2017, the contents of which are incorporated by reference in their entirety.

### FIELD OF THE INVENTION

The present description relates generally to portable devices used for illuminating spaces.

### BACKGROUND OF THE INVENTION

Advances in technology have enabled lighting devices to become increasingly lightweight and portable. Light emitting diodes (LEDs) are capable of efficiently converting electrical energy into light with little waste heat, allowing them to provide extended illumination with portable energy sources, such as batteries.

Portable lanterns and the like are used in a variety of situations. Some are used for area illumination in spaces without dedicated lighting. Others are used for increasing visibility in hard to reach place like under vehicles. These devices are especially useful in the event of external power loss.

It is an object of this disclosure to provide an improved portable lighting solution that can be carried by a user to provide light in the area they are working as needed.

It is a further object of this disclosure to provide an improved portable lighting solution with a longer lasting power source.

It is a further object of this disclosure to provide an improved portable lighting solution that is dust and water resistant.

### SUMMARY OF THE INVENTION

A portable light comprises a housing with a front portion, a back portion, and a handle. The front portion including a cross shaped support portion and a finned portion. A lighting element is centrally positioned in the front portion. A rotatable stand is connected to the housing at each side. A battery system is coupled to an inside of the housing and operably connected to and enabling the lighting element to emit light with a switch as part of a control panel built into the rear portion of the housing. The finned portion is operably connected to the lighting element to dissipate heat.

A portable light comprises a housing with a front portion, a back portion, and a handle. The front portion includes a cross shaped support portion and an aluminum finned portion. An LED lighting element is centrally positioned in the front portion which is substantially surrounded by a phosphorescent material. A rotatable stand is connected to the housing at each side. A rechargeable battery system coupled to an inside of the housing and operably connected to and enabling the lighting element to emit light. A switch is part of a control panel built into the rear portion of the housing. The control panel includes a wireless Bluetooth transceiver adapted to connect to a user device. A charging port is located on the rear portion of the housing electrically connected to the rechargeable battery system. The finned portion is operably connected to the lighting element to dissipate heat.

### BRIEF DESCRIPTION OF THE DRAWINGS

FIG. 1 is a perspective view of the portable light according to the methods of this disclosure of FIG. 1.

FIG. 2 is a top perspective view of the portable light with the stand deployed of FIG. 1.

FIG. 3 is a back perspective view of the folded portable light of FIG. 1.

FIG. 4 is a front view of the portable light of FIG. 1.

FIG. 5 is a back view of the portable light of FIG. 1.

FIG. 6 is a left view of another example portable light of FIG. 1.

FIG. 7 is a right view of the portable light of FIG. 1.

FIG. 8 is a top view of the portable light of FIG. 1.

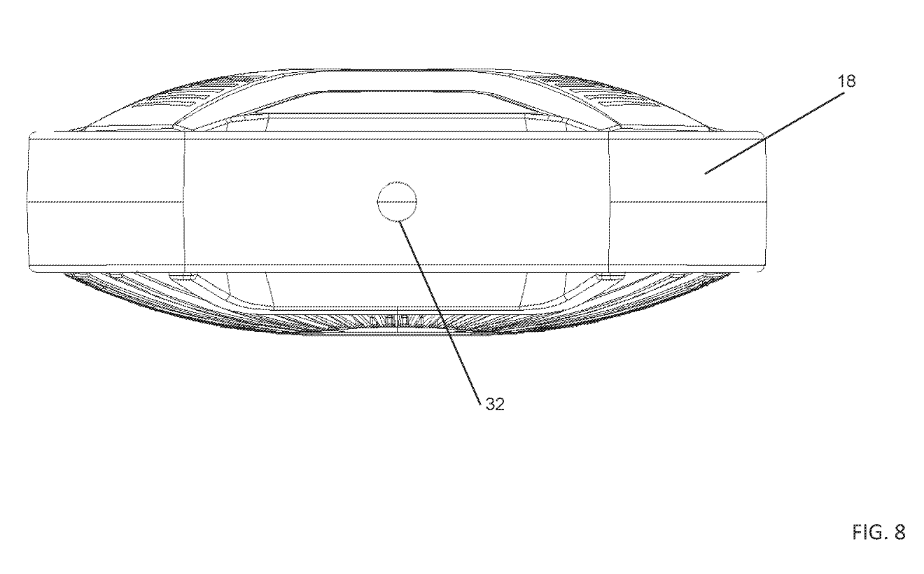

FIG. 9 is a bottom view of the portable light of FIG. 1.

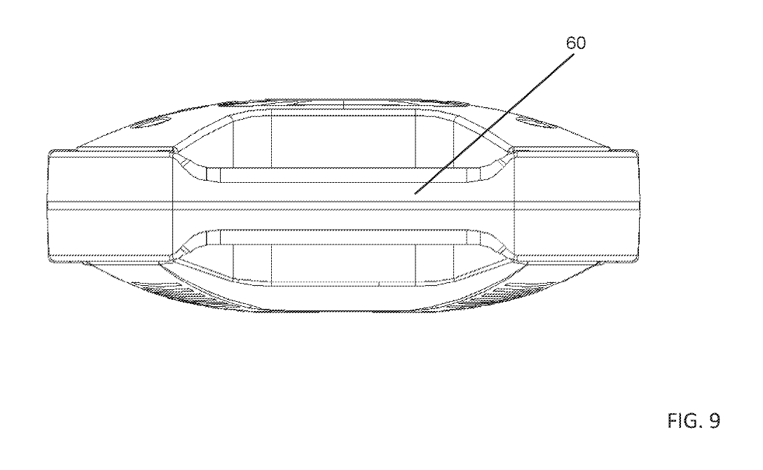

FIG. 10 is a perspective view of another portable light according to the invention.

FIG. 11 is a top perspective view of the portable light of FIG. 10 with the stand deployed.

FIG. 12 is a back perspective view of the folded portable light of FIG. 10.

FIG. 13 is a front view of the portable light of FIG. 10.

FIG. 14 is a back view of the portable light of FIG. 10.

FIG. 15 is a left view of another example portable light of FIG. 10.

FIG. 16 is a right view of the portable light of FIG. 10.

FIG. 17 is a top view of the portable light of FIG. 10.

FIG. 18 is a bottom view of the portable light of FIG. 10.

### DETAILED DESCRIPTION OF THE INVENTION

The following description of example methods and apparatus is not intended to limit the scope of the description to the precise form or forms detailed herein. Instead the following description is intended to be illustrative so that others may follow its teachings.

In the following description, the terms “water resistant” or “dust resistant” are used. These terms are set under ANSI/IEC-60529 which promulgates certain standards for the degrees of protection granted against intrusion by both solid objects and water. Solid objections include dust, debris, and even accidental conduct by the user's body during use. The terms “water resistant” or “dust resistant” on their own do not necessarily mean that no dust or no water will enter the device.

The terms “light emitting diode” and “LED” are also used in the following description. One of ordinary skill will appreciate that an LED describes a wide variety of two lead semiconductors that emit light by electroluminescence when a voltage differential is applied. LED lights can be made in a variety of sizes and typically come in either through-hole or surface mount configurations.

The term “phosphorescence” is also used in the following description. Phosphorescence refers to a mechanism by which a material fluoresces when exposed to radiation. This mechanism is associated with unsuitable energy state transitions in quantum mechanics. A phosphorescence material does not immediately re-emit the radiation it absorbs, but instead absorbed radiation is re-emitted at a lower intensity for up to several hours after the original excitation.

The present application discloses a multi-functional high efficiency LED Area portable light. The portable light includes a cross shaped housing with a front portion and a back portion. In the front portion, an LED lighting element is centrally positioned. Part of the housing is a series of aluminum cooling fins. A rotatable stand and handle are connected to the housing at the top and bottom respectively. At the rear of the portable light, a switch and charging port are built into the rear portion of the housing.

The example multi-functional portable light may be powered via replaceable or rechargeable batteries. In some instances, the portable light includes a charging port into which a connector of a power source can be inserted to supply power to rechargeable batteries of the multi-functional portable light. In other instances, the multi-functional portable light includes a receptacle with conductive contacts into which one or more batteries may be inserted for powering the portable light.

In one example situation, the user, when additional lighting is needed as in a power outage or repair task, uses the switch to activate the LED lighting element. The user can use the stand and mounting point to locate and secure the portable light in the most helpful location. The charging port can be used to power the device or recharge the battery. After the user is finished, the user can use the switch to disable the light.

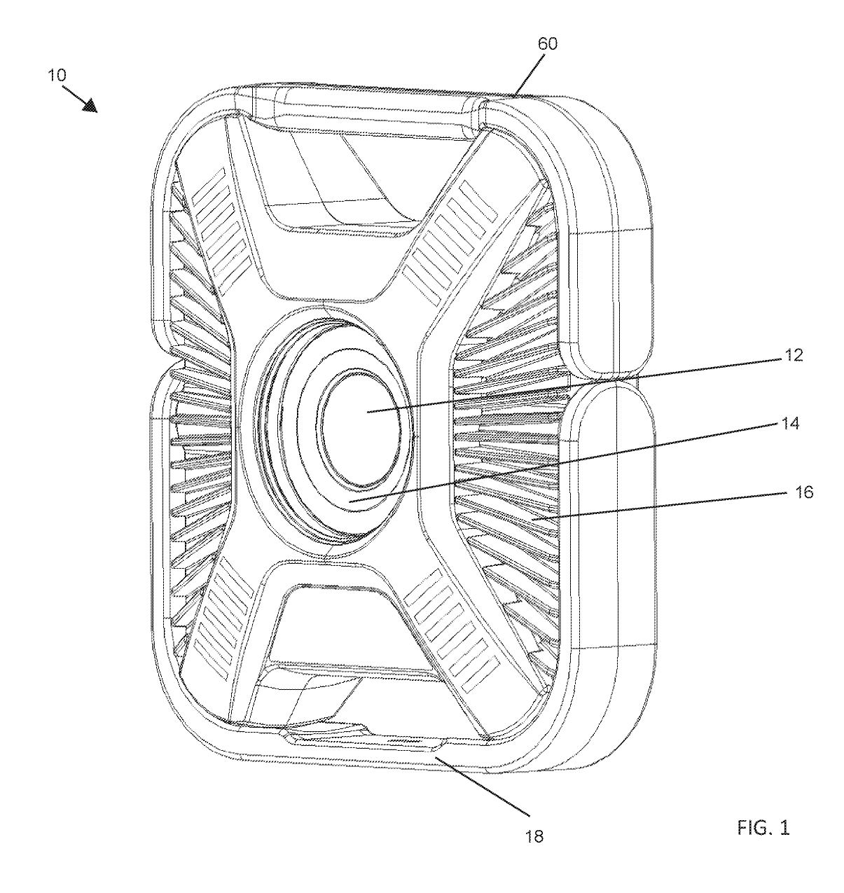

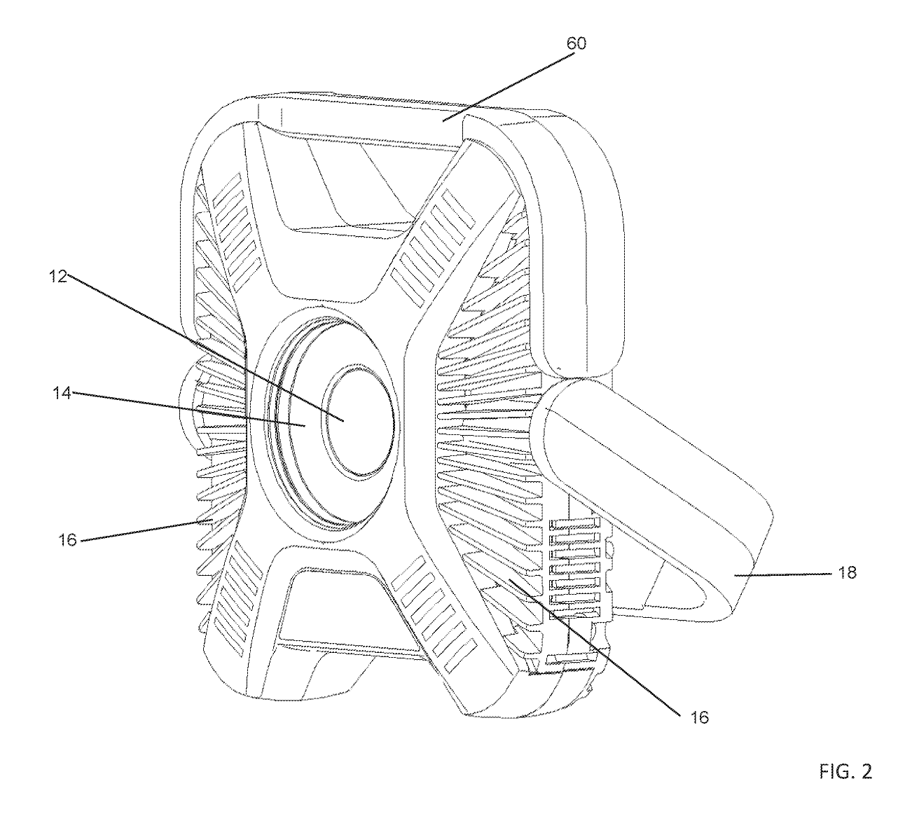

Referring now to FIG. 1, an example of a portable light 10 is shown. In the example portable light 10, the housing 16 is shaped in an “x” or cross configuration and has a rotating support bracket 18, shown extended in FIG. 2. This example configuration efficiently distributes the material to maximize strength while minimizing material usage and costs.

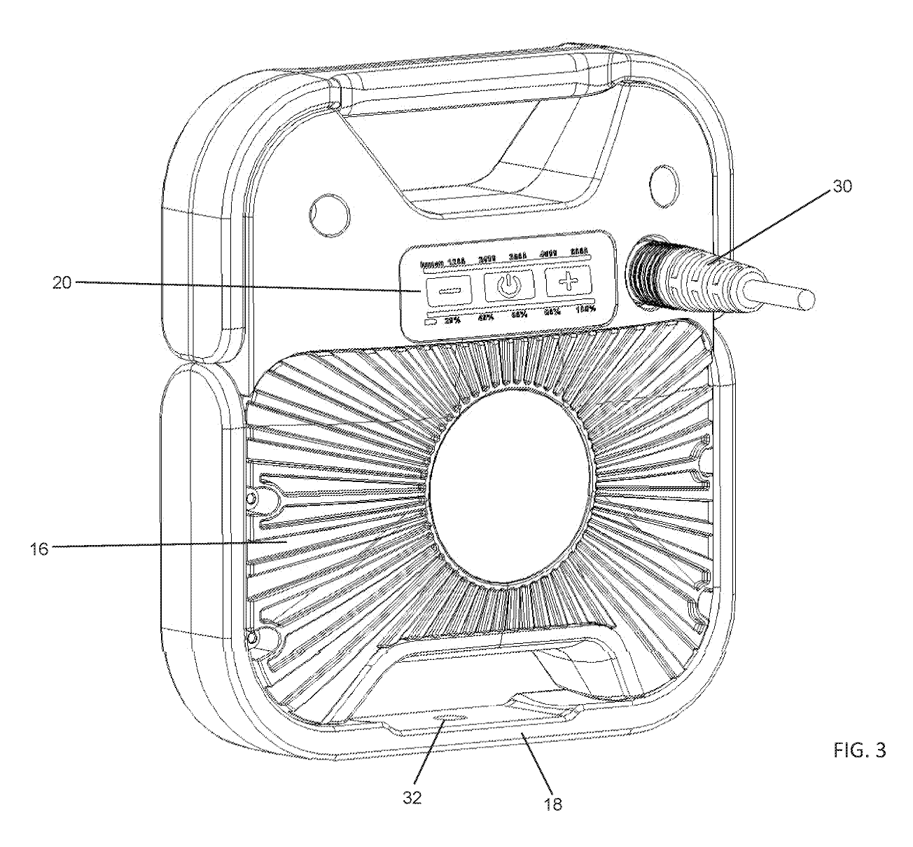

The housing 16 is an aluminum finned design extending across large portions of the front and back of the device as shown in FIGS. 2-3. The housing 16 is constructed of high quality aluminum, and the fins are designed for heat dissipation and impact resistance. The configuration is a strong construction design that allows product to drop safely from two meters.

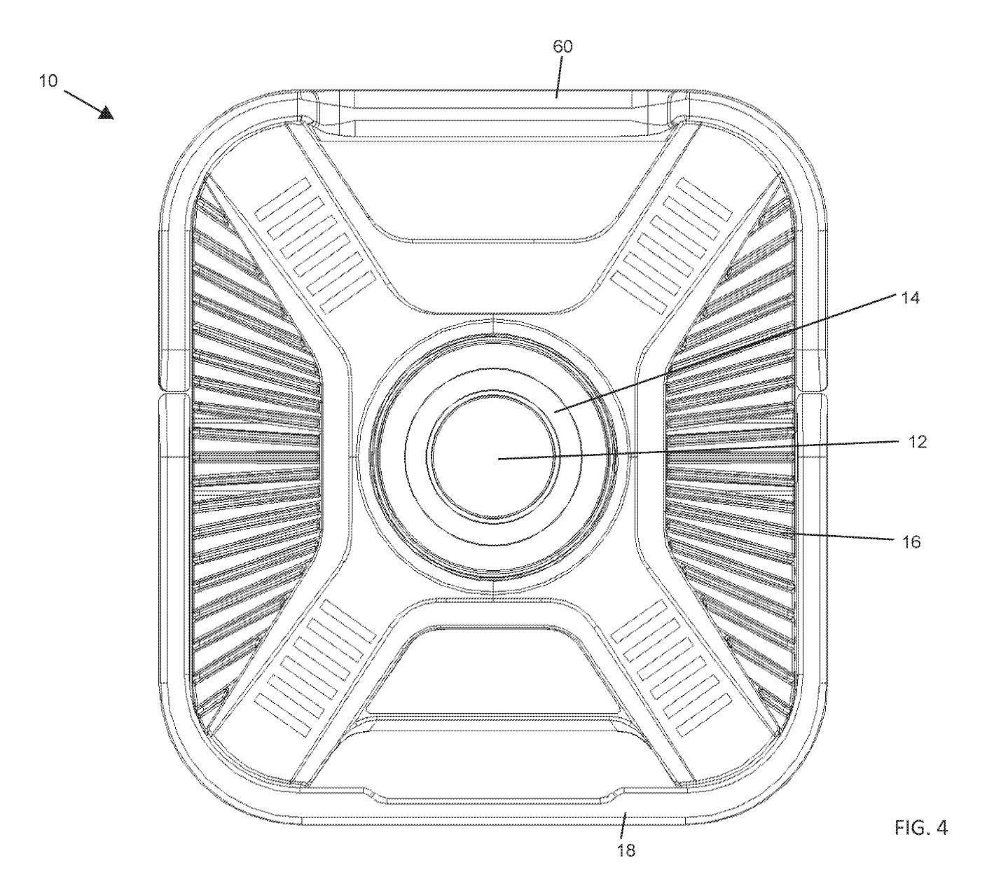

The front face of the portable light 10 includes a high efficiency chip on board (“COB”) forward LED 12 used to illuminate, as shown in FIG. 4. A borosilicate glass lens protects the forward LED 12 in the example portable light shown. The forward LED 12 is a high color rendition index chips on board LED. A reflector 14 is positioned around the LED 12 to better direct the light away from the device. It is contemplated that other light emitting technologies can be used in place of LED 12 including techniques such as arc, incandescent, and florescent bulbs. The reflector 14 is also a phosphorescent material which can make it easier to find the portable light 10 in the dark, especially if the device is accidentally turned off.

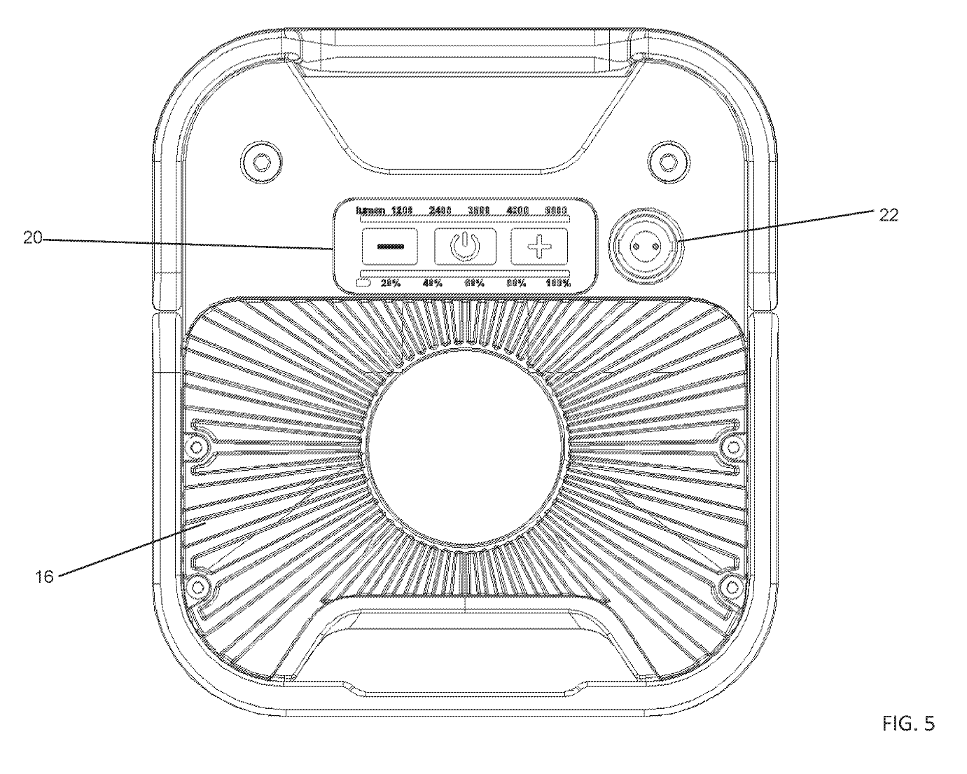

In the rear view shown in FIG. 5, a control panel 20 is shown. This control panel shows a variety of controls and displays. In the example shown in FIG. 5, there is a switch for activating the device and dimmer controls for adjusting the brightness of the forward LED 12. In addition to brightness control, the system can adjust the color temperature of the forward LED 12 allowing the user to select a calming yellow-white light, a clean blue-white. This luminous flux adjustment by dimmer controls can be accomplished manually or by Bluetooth control by a user device, such as a cell phone or tablet for use of the dimmer function. In this example, the portable light 10 will contain a wireless transceiver for Bluetooth communication with a user device. One of ordinary skill in the art will understand that the transceiver can be used or adapted for a wide range of wireless technologies such as WiFi, WiLAN, or any other suitable means of communication.

The portable light 10 contains a lithium-ion rechargeable battery to provide power to the rest of the device. A charging port 22 is shown on the back of light 10. This enables an “R+C system,” where R is “rechargeable” and C is “cable”. The product can be charged as DC type unit, using the lithium-ion battery, but it also can be used with the cable hooked into external power as a conventional AC type electrical device.

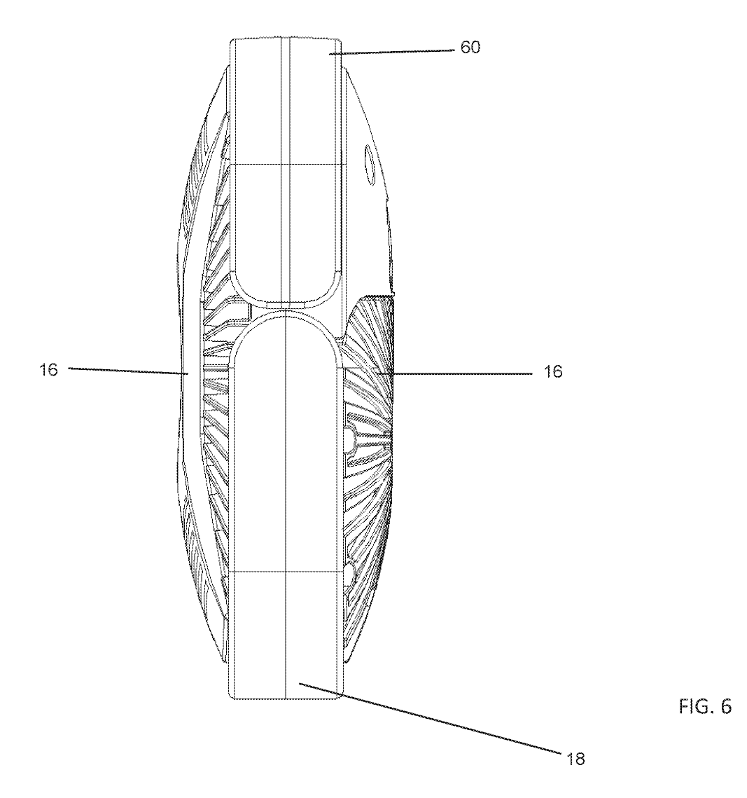

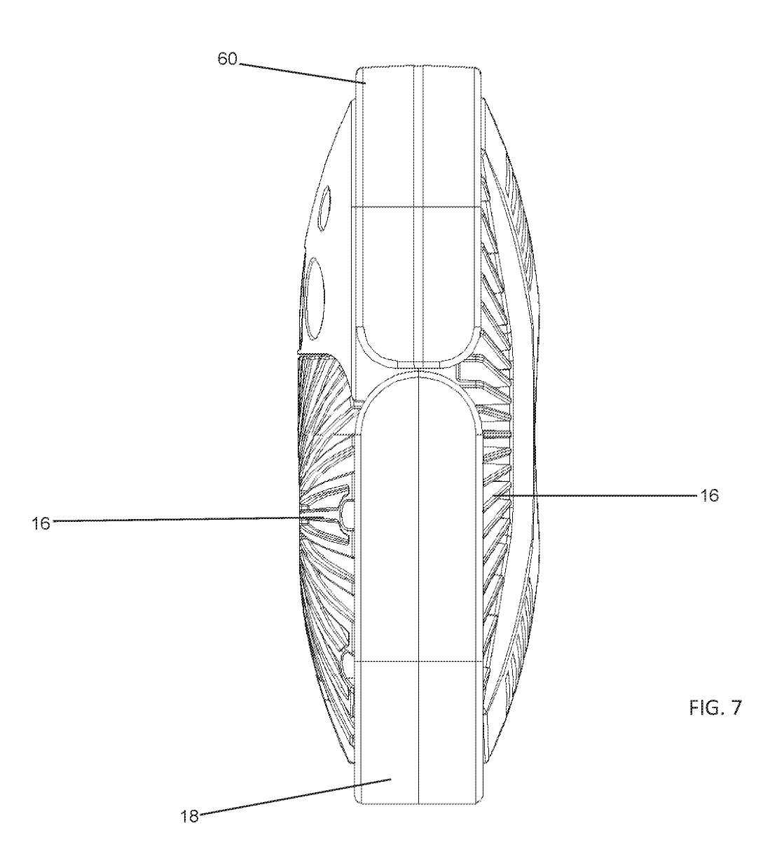

As shown in FIGS. 6-7, the example portable light also includes a handle 60 and the rotating support bracket 18. The handle makes the portable light 10 more easily carried. The rotating support bracket 18 has a mounting point 32 which allows the portable light to be affixed to a tripod or other accessories. The rotating support bracket 18 can serve as a leg or stand alone, or as a pivot when the portable light 10 is mounted.

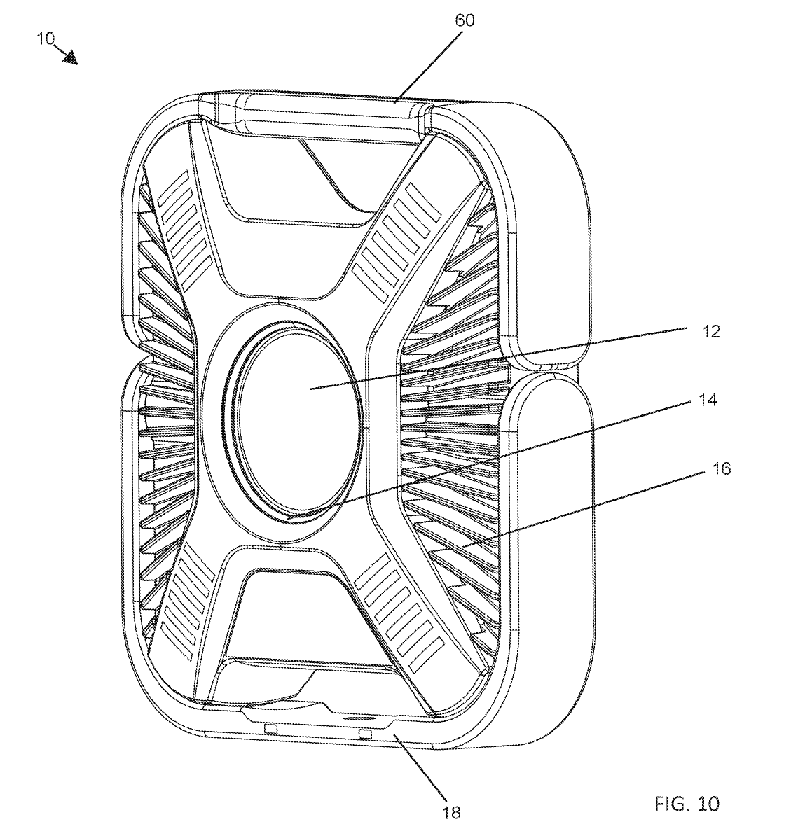

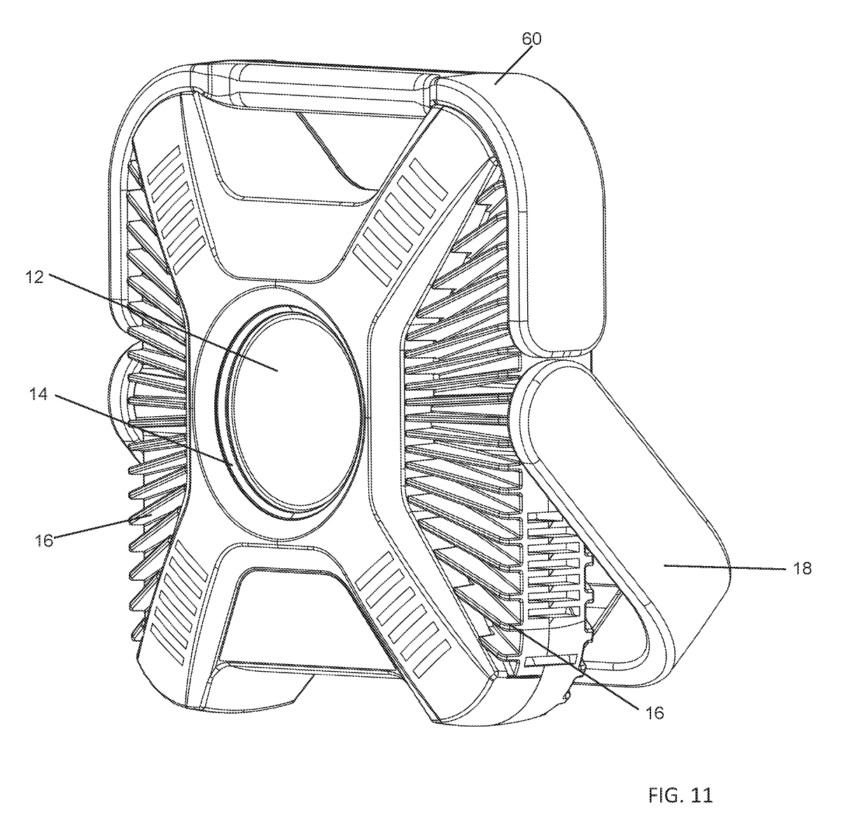

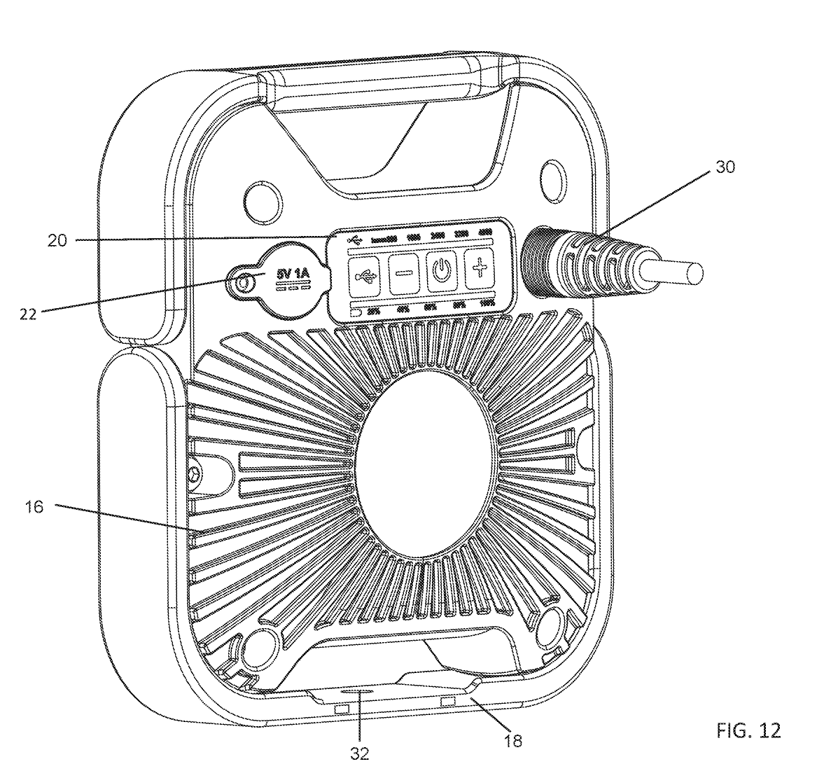

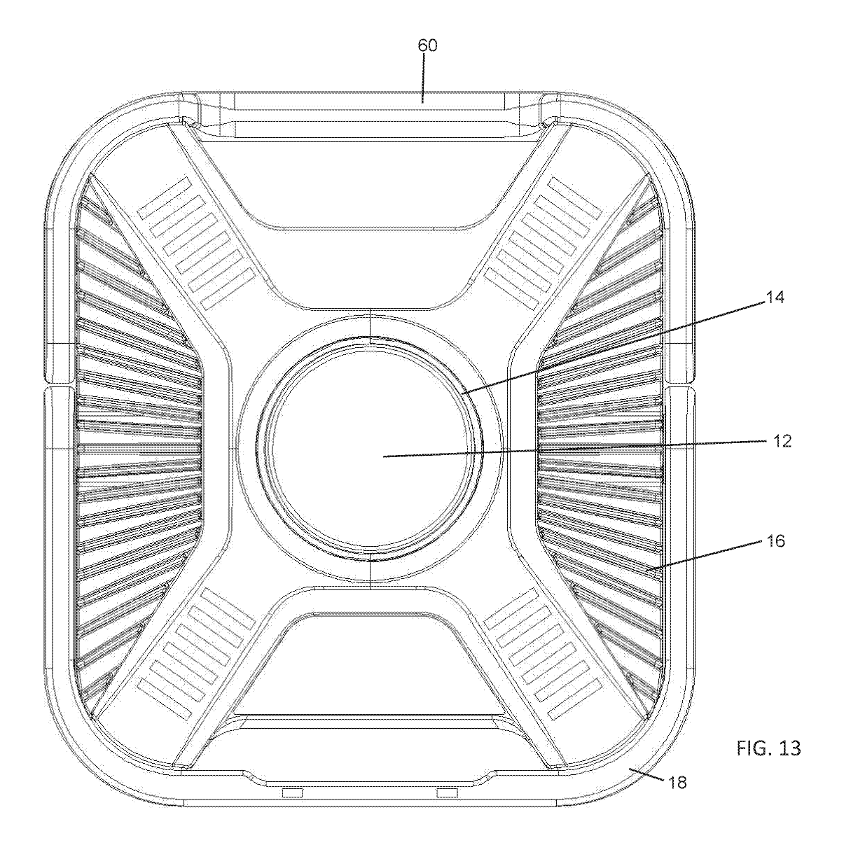

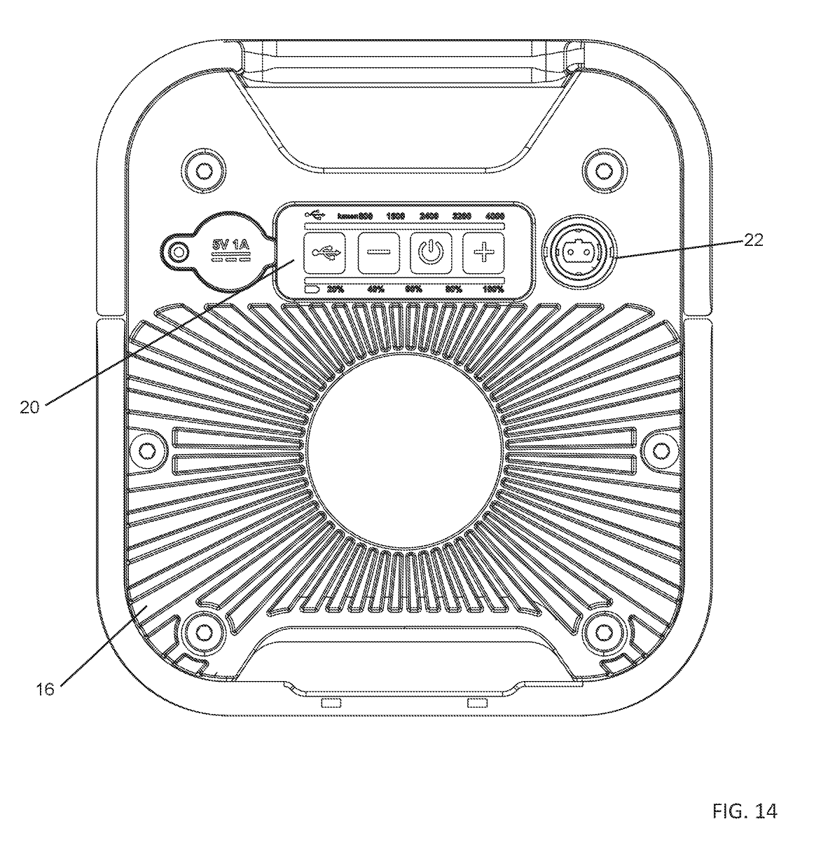

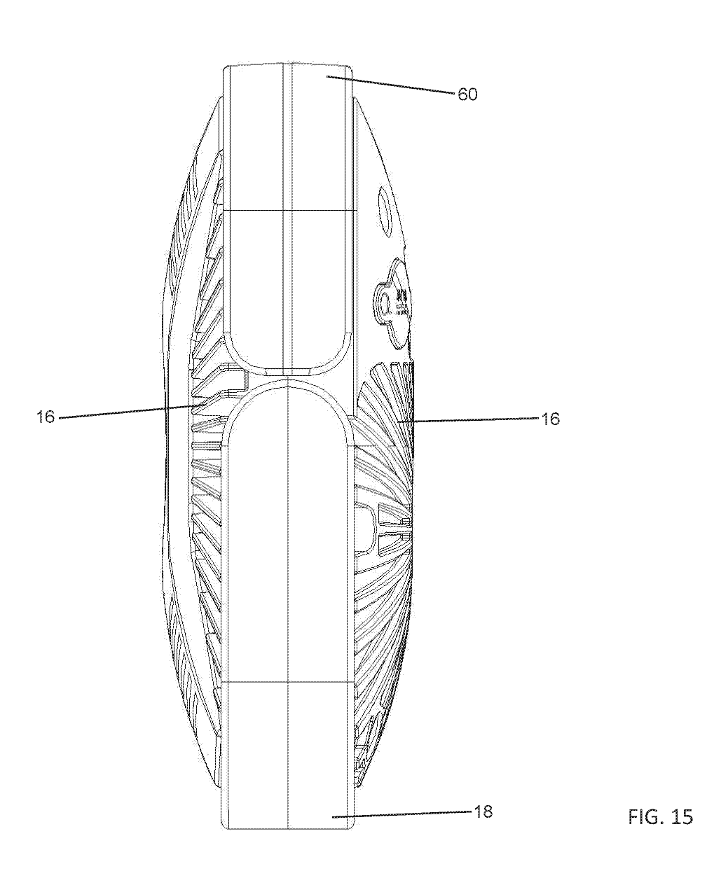

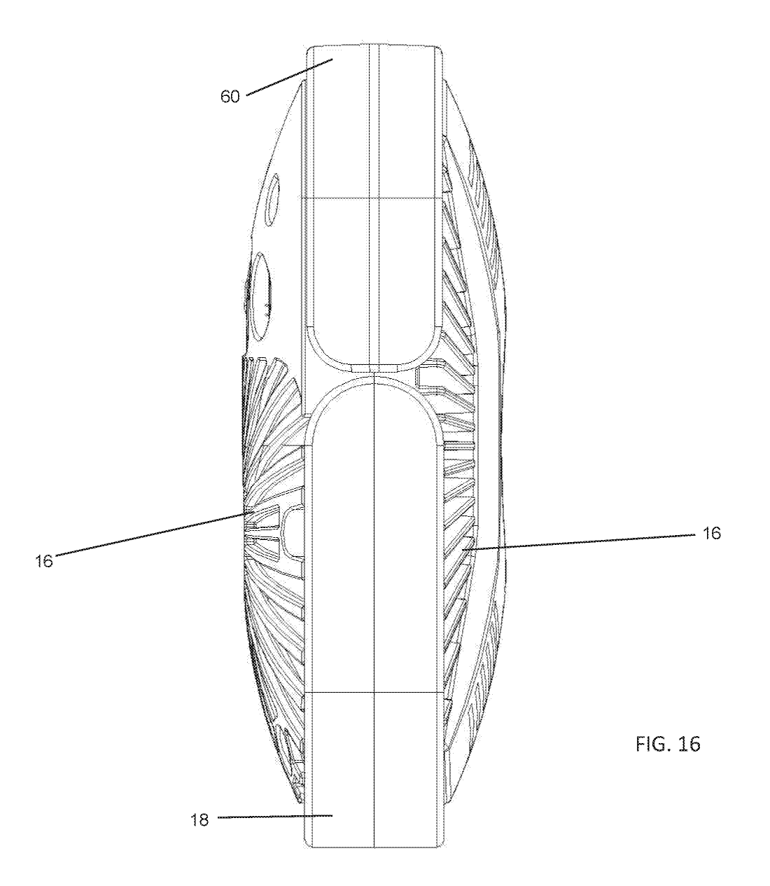

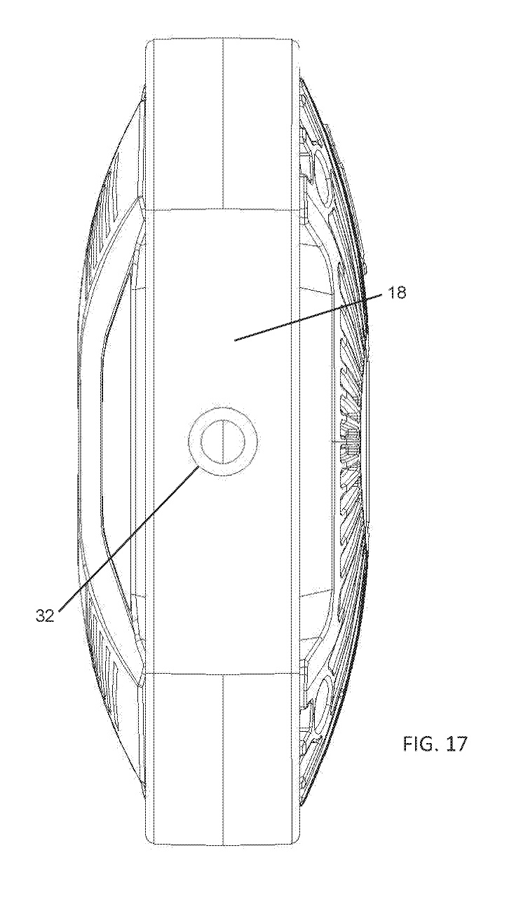

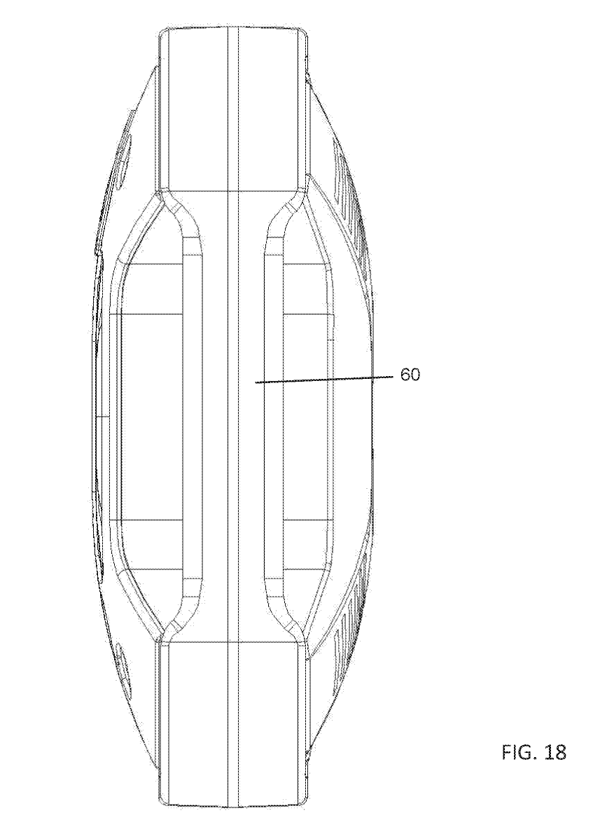

As shown in FIGS. 10-18, another example portable according to the teachings of the disclosure is presented. As shown in FIG. 12, this portable light has a different control panel 20 which includes a discharging port 22, shown as a USB port in the figures. The discharging port 22 allows the user to use the internal battery of the portable light to charge other devices in situ. This port could also be used for data transmission, one or two way, allowing the user to, for example, download usage statistics or battery information.

The portable light 10 is rated IP67 for water and dust resistance and can be used indoors and outdoors. The design of portable light 10 prevents contact and the ingress of dust of more than a de minimis amount that provides no harm to the function of the device. It is also shielded from splashing water such that incidental contact with but not submersion in water.

Although certain example methods and apparatus have been described herein, the scope of coverage of this patent is not limited thereto. On the contrary, this patent covers all methods, apparatus, and articles of manufacture fairly falling within the scope of the appended claims either literally or under the doctrine of equivalents.

What is claimed is:

1. A portable light comprising:
a housing with a front portion, a back portion, and a handle, the front portion including a cross shaped support portion and a finned portion;
a lighting element centrally positioned in the front portion;
a stand rotably connected to the housing at the sides;
a battery system coupled to an inside of the housing and operably connected to and enabling the lighting element to emit light; and
a switch as part of a control panel built into the rear portion of the housing;
wherein the finned portion is operably connected to the lighting element to dissipate heat.

2. The portable light of claim 1 wherein the battery system is rechargeable.

3. The portable light of claim 2 further comprising a charging port on the rear portion of the housing electrically connected to the rechargeable battery system.

4. The portable light of claim 1 further comprising a wireless transceiver operable to connect to a user device.

5. The portable light of claim 4 wherein the wireless transceiver operates via Bluetooth.

6. The portable light system of claim 1 further comprising a phosphorescent material placed proximate to either the lighting element.

7. The portable light system of claim 6 wherein the phosphorescent material is formed substantially around the lighting element.

8. The portable light of claim 1 wherein the lighting element is a high power SMD LED.

9. The portable light system of claim 1 wherein the portable lighting system is adapted to be protected against dust and water.

10. The portable light system of claim 1 wherein the finned portion is made of aluminum.

11. A method of using a portable light as shown and described.

12. A portable light comprising:
a housing with a front portion, a back portion, and a handle, the front portion including a cross shaped support portion and an aluminum finned portion;
an LED lighting element centrally positioned in the front portion with a phosphorescent material formed substantially around the lighting element;
a stand rotably connected to the housing at the sides; and
a rechargeable battery system coupled to an inside of the housing and operably connected to and enabling the lighting element to emit light;
a switch as part of a control panel built into the rear portion of the housing, the control panel operably connected to a wireless Bluetooth transceiver adapted to connect to a user device; and
a charging port located on the rear portion of the housing electrically connected to the rechargeable battery system;
wherein the finned portion is operably connected to the lighting element to dissipate heat.

13. The portable light system of claim 12 wherein the portable lighting system is adapted to be protected against dust and water.
